(19) United States
(12) Patent Application Publication
(10) Pub. No.: US 2026/0257501 A1
(43) Pub. Date: Sep. 3, 2026

(54) PRINTING AND CUTTING MACHINE

(71) Applicant: Huansheng Intelligent (Shenzhen) Co., Ltd., Shenzhen (CN)

(72) Inventors: Mingliang GAO, Shenzhen (CN); Jiandu HE, Shenzhen (CN); Guangping HU, Shenzhen (CN); Xingjin LIAO, Shenzhen (CN); Tian MEI, Shenzhen (CN)

(21) Appl. No.: 19/658,743

(22) Filed: Apr. 27, 2026

(30) Foreign Application Priority Data
Mar. 31, 2026 (CN) 202620423446.3

(51) Int. Cl. B41J 11/70; B41J 2/165; B41J 25/00; B41J 29/393

(52) U.S. Cl. CPC B41J 11/706; B41J 2/16508; B41J 25/005; B41J 29/393; B41P 2235/21

(57) ABSTRACT

A printing and cutting machine, including: a body, a guide shaft, a driving device, a transmission device, a cutting device, and an inkjet device detachably. The guide shaft is disposed on the body, the driving device is disposed on the body, the transmission device is disposed on the body and in transmission connection with the driving device. The inkjet device detachably connected to the cutting device. Either the cutting device or the inkjet device is slidably connected to the guide shaft and is connected to the transmission device.

### CROSS REFERENCE TO RELATED APPLICATIONS

This application claims priority to Chinese Patent Application No. 202620423446.3, filed on Mar. 31, 2026 in the China National Intellectual Property Administration, the entire disclosure of which is hereby incorporated by reference.

### TECHNICAL FIELD

The present disclosure relates to the technical field of printing and cutting technology, in particular to a printing and cutting machine.

### BACKGROUND

In industries such as advertising material production, graphic quick-printing, and office equipment consumables processing, materials, after being printed, often still need to undergo precise cutting according to design requirements. Therefore, the use of cutting equipment is extremely widespread. However, traditional solutions have always separated the printing process from the cutting process, with dedicated printing equipment completing the printing and dedicated cutting equipment completing the cutting. This makes existing cutting equipment unable to simultaneously possess both printing and cutting functions, strictly limiting its application scenarios to single cutting operations and making it difficult to meet the demands of integrated and intelligent production.

### SUMMARY

The present disclosure provides a printing and cutting machine, to realize printing and cutting functions, so as to enhance the application scenarios of the printing and cutting machine.

To realize the above objective, the present disclosure provides a printing and cutting machine, including: a body; a guide shaft disposed on the body; a driving device disposed on the body; a transmission device disposed on the body and in transmission connection with the driving device; a cutting device; and an inkjet device detachably connected to the cutting device; either the cutting device or the inkjet device is slidably connected to the guide shaft and is connected to the transmission deviceBy providing separably connected cutting device and inkjet device, either the inkjet device or the cutting device is slidably connected with the guide shaft and slidably connected with the guide shaft is connected with the transmission device. The printing and cutting machine is enabled to simultaneously realize the printing function and the cutting function, thereby enhancing the diversity of application scenarios of the printing and cutting machine. Moreover, because the inkjet device is separably connected with the cutting device, either the inkjet device or the cutting device is slidably connected with the guide shaft and is connected with the transmission device and can be separated from the printing and cutting machine, thereby enhancing the flexibility of the printing and cutting machine during use.

### BRIEF DESCRIPTION OF THE DRAWINGS

FIG. 1 is a schematic structural diagram of a printing and cutting machine according to an embodiment of the present disclosure.

FIG. 2 is an exploded view of the printing and cutting machine.

FIG. 3 is a schematic structural diagram of the cutting device of the printing and cutting machine.

FIG. 4 is an exploded view of the cutting device of the printing and cutting machine.

FIG. 5 is a schematic structural diagram of the inkjet device of the printing and cutting machine.

FIG. 6 is an exploded view of the inkjet device of the printing and cutting machine.

FIG. 7 is a schematic view of the internal structure of the printing and cutting machine.

FIG. 8 is an enlarged view of position A in FIG. 7.

FIG. 9 is a schematic structural diagram of a first mounting base of a moisturizing device of the printing and cutting machine.

FIG. 10 is a schematic structural diagram of a second mounting base of the moisturizing device of the printing and cutting machine.

### DESCRIPTION OF THE REFERENCE NUMERALS

10 printing and cutting machine; 100 body; 200 guide shaft; 300 driving device; 400 transmission device, 410 conveyor belt; 500 cutting device, 510 first base, 511 first surface, 5111 first groove, 5112 positioning post, 520 first magnetic assembly, 521 first magnetic component, 530 first connection terminal; 600 inkjet device, 610 second mounting base, 611 second surface, 6111 second groove, 6112 positioning groove, 620 second magnetic assembly, 621 second magnetic component, 630 print head, 640 second connection terminal; 700 moisturizing device, 710 first mounting base, 711 mounting cavity, 712 first side plate, 7121 guide groove, 7121 a horizontal section, 7121 b inclined section, 720 second mounting base, 721 second side plate, 7211 guide post, 730 moisturizing component, 731 accommodating cavity, 740 scraper; 750 reset component.

### DETAILED DESCRIPTION OF THE EMBODIMENTS

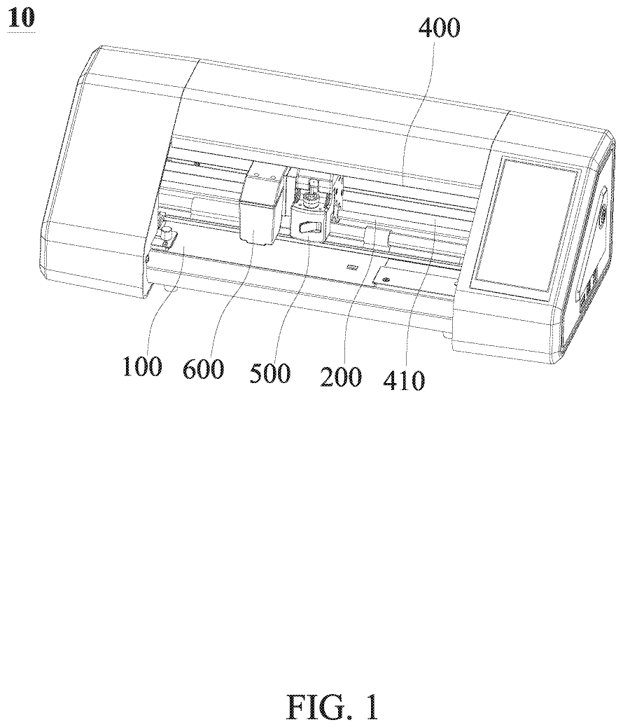

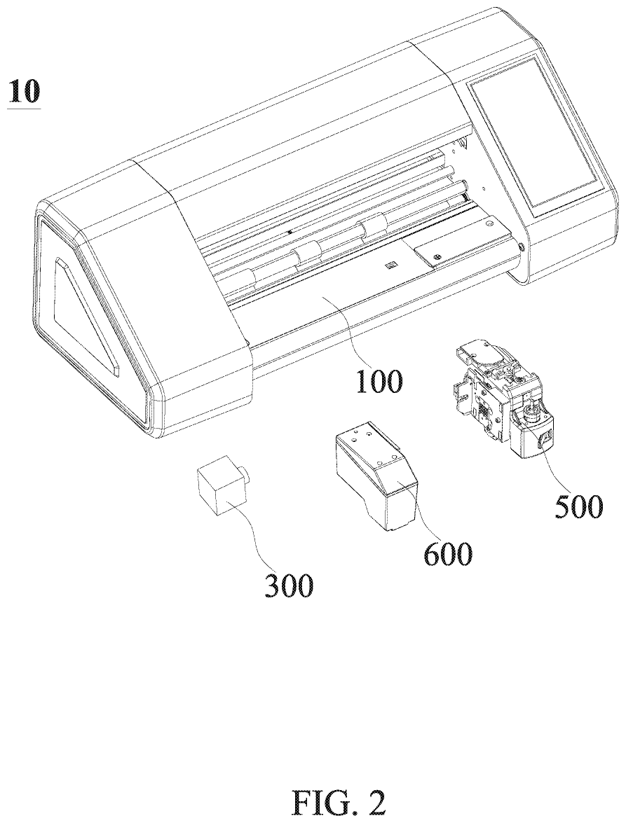

A first embodiment of the present disclosure provides a printing and cutting machine. Referring to FIG. 1 and FIG. 2, the printing and cutting machine 10 includes a body 100, a guide shaft 200, a driving device 300, a transmission device 400, a cutting device 500, and an inkjet device 600. The guide shaft 200 is disposed on the body 100. The driving device 300 is disposed on the body 100. The transmission device 400 is disposed on the body 100. The transmission device 400 is in transmission connection with the driving device 300. The inkjet device 600 is separably connected with the cutting device 500, the cutting device 500 is slidably connected with the guide shaft 200. The cutting device 500 is connected with the transmission device 400.

In industries such as advertising material production, graphic quick-printing, and office equipment consumables processing, materials, after being printed, often still need to undergo precise cutting according to design requirements. Therefore, the use of cutting equipment is extremely widespread. However, traditional solutions have always separated the printing process from the cutting process, with dedicated printing equipment completing the printing and dedicated cutting equipment completing the cutting. This makes existing cutting equipment unable to simultaneously possess both printing and cutting functions, strictly limiting its application scenarios to single cutting operations and making it difficult to meet the demands of integrated and intelligent production. Therefore, the present disclosure provides a printing and cutting machine. By providing the cutting device 500 and the inkjet device 600 of the printing and cutting machine, and by providing that the inkjet device 600 is separably connected with the cutting device 500, the inkjet device 600 is slidably connected with the guide shaft 200, and the inkjet device 600 is connected with the transmission device 400, the printing and cutting machine is enabled to simultaneously realize the printing function and the cutting function, thereby enhancing the diversity of application scenarios of the printing and cutting machine. Moreover, because the inkjet device 600 is separably connected with the cutting device 500, the inkjet device 600 is slidably connected with the guide shaft 200, and the inkjet device 600 is connected with the transmission device 400, when the printing and cutting machine is in use, the inkjet device 600 and the cutting device 500 can be disassembled and separated from each other, so that the printing and cutting machine can be used alone as a cutting machine, thereby enhancing the flexibility of the printing and cutting machine during use.

As one mode of use of the printing and cutting machine of the present disclosure, when it is necessary to perform both printing and cutting functions on a material, the inkjet device 600 is connected together with the cutting device 500 during use of the printing and cutting machine. The inkjet device 600 is first controlled to operate a printing process on the material. After the printing process is completed, the cutting device 500 is controlled to operate a cutting process and the inkjet device 600 stops the printing process, thereby realizing the printing and cutting functions of the printing and cutting machine 10.

As another mode of use of the printing and cutting machine of the present disclosure, the inkjet device 600 is separated from the cutting device 500 so as to disassemble the inkjet device 600 from the printing and cutting machine, whereby the printing and cutting machine can be used as a device that possesses only the cutting function and does not possess the printing function.

It should be noted that, in the present embodiment, the inkjet device 600 is separably connected with the cutting device 500, the cutting device 500 is slidably connected with the guide shaft 200, and the cutting device 500 is connected with the transmission device 400. That is, the cutting device 500 is an inseparable part of the printing and cutting machine, and the inkjet device 600 is separably connected with the cutting device 500 and is not connected with other components of the printing and cutting machine. Therefore, the inkjet device 600 can be separately disassembled from the printing and cutting machine, so that the printing and cutting machine can be used alone as a cutting machine.

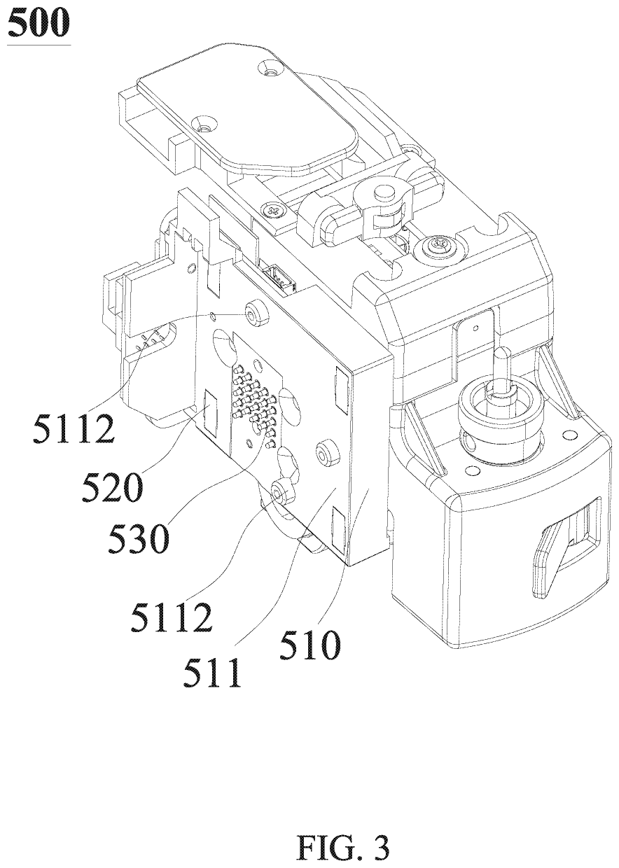

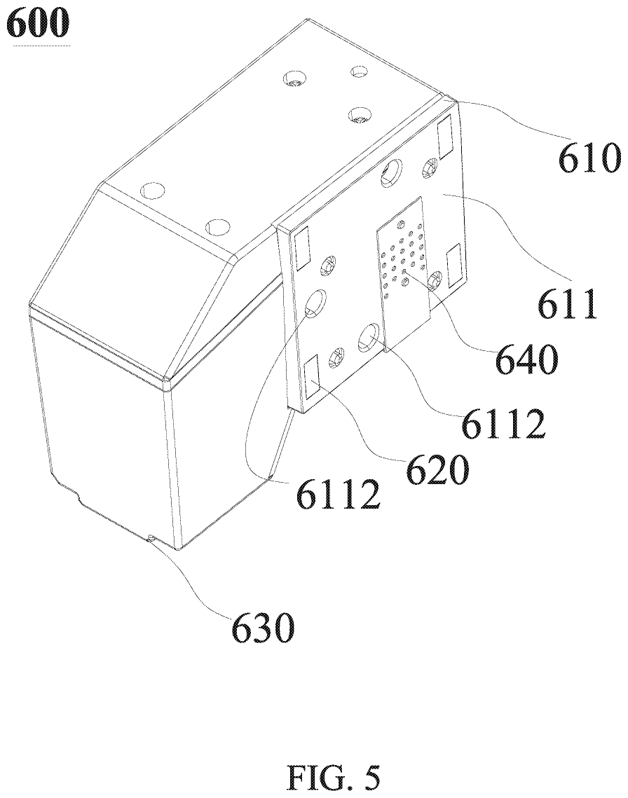

In the present embodiment, referring to FIG. 3 and FIG. 5, the cutting device 500 includes a first base 510, the inkjet device 600 includes a second mounting base 610. The first base 510 has a first surface 511, and the second mounting base 610 has a second surface 611. The cutting device 500 further includes a first magnetic assembly 520, the first magnetic assembly 520 is disposed on the first surface 511, the inkjet device 600 further includes a second magnetic assembly 620, the second magnetic assembly 620 is disposed on the second surface 611. The second magnetic assembly 620 is magnetically attracted and connected with the first magnetic assembly 520.

It can be understood that, in the present embodiment, because the cutting device 500 is provided with the first magnetic assembly 520, the first magnetic assembly 520 is disposed on the first surface 511, the inkjet device 600 further includes the second magnetic assembly 620, the second magnetic assembly 620 is disposed on the second surface 611, and the second magnetic assembly 620 is magnetically attracted and connected with the first magnetic assembly 520. So the separable connection between the inkjet device 600 and the cutting device 500 is realized by using the first magnetic assembly 520 and the second magnetic assembly 620. Thereby enhancing the convenience of disassembly of the inkjet device 600 or the cutting device 500.

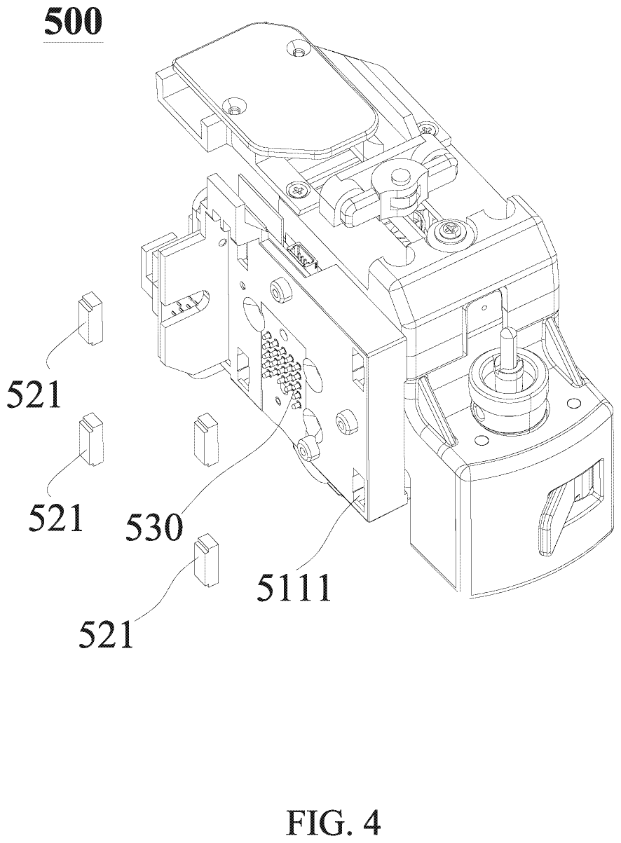

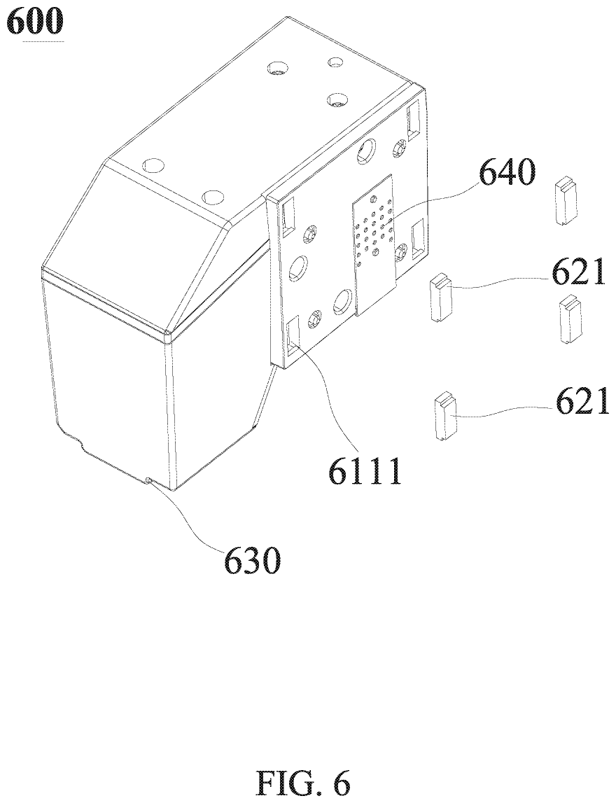

In the present embodiment, referring to FIG. 4 and FIG. 6, the first surface 511 is provided with a first groove 5111, and the second surface 611 is provided with a second groove 6111. At least a portion of the first magnetic assembly 520 is disposed in the first groove 5111, and at least a portion of the second magnetic assembly 620 is disposed in the second groove 6111.

It can be understood that, in the present embodiment, since the first surface 511 is provided with a first groove 5111 and the second surface 611 is provided with a second groove 6111. At least a portion of the first magnetic assembly 520 is disposed within the first groove 5111 and at least a portion of the second magnetic assembly 620 is disposed within the second groove 6111. Such that at least a portion of the first magnetic assembly 520 is concealed within the first groove 5111 and at least a portion of the second magnetic assembly 620 is concealed within the second groove 6111. The position of the first magnetic assembly 520 and the second magnetic assembly 620 can be prevented from being displaced during operation of the printing and cutting machine, and the risk of the first magnetic assembly 520 and the second magnetic assembly 620 becoming detached can also be reduced, thereby ensuring the stability of the connection between the inkjet device 600 and the cutting device 500.

In the present embodiment, referring to FIG. 3 and FIG. 5, a surface of the first magnetic assembly 520 away from a bottom of the first groove 5111 is flush with the first surface 511, and a surface of the second magnetic assembly 620 away from the bottom of the second groove 6111 is flush with the second surface 611.

In the present embodiment, a portion of the first magnetic assembly 520 is received within the first groove 5111 and a portion of the first magnetic assembly 520 protrudes outward from the first groove 5111, while a portion of the second magnetic assembly 620 is received within the second groove 6111 and a portion of the second magnetic assembly 620 protrudes outward from the second groove 6111.

It can be understood that, in the present embodiment, since a portion of the first magnetic assembly 520 is received within the first groove 5111 and a portion of the first magnetic assembly 520 protrudes outward from the first groove 5111. A portion of the second magnetic assembly 620 is received within the second groove 6111 and a portion of the second magnetic assembly 620 protrudes outward from the second groove 6111. That is, a portion of the first magnetic assembly 520 protrudes outward from the first groove 5111, and a portion of the second magnetic assembly 620 protrudes outward from the second groove 6111. The magnetic attraction between the first magnetic assembly 520 and the second magnetic assembly 620 is advantageously increased, thereby enhancing the connection stability between the inkjet device 600 and the cutting device 500.

In the present embodiment, referring to FIG. 3 and FIG. 5, the first magnetic assembly 520 includes a plurality of first magnetic components 521 arranged at intervals. The second magnetic assembly 620 includes a plurality of second magnetic components 621 arranged at intervals, each of the second magnetic components 621 corresponds to each of the plurality of the first magnetic components 521.

It can be understood that, in the present embodiment, the first magnetic assembly 520 includes the plurality of first magnetic components 521 arranged at intervals. The second magnetic assembly 620 includes the plurality of second magnetic components 621 arranged at intervals, each of the second magnetic components 621 corresponds to each of the plurality of first magnetic components 521. That is, the connection between the inkjet device 600 and the cutting device 500 is realized by means of multi-point fixation, such that the inkjet device 600 and the cutting device 500 can achieve multi-point fixation at a plurality of positions, thereby enhancing the stability of the connection between the inkjet device 600 and the cutting device 500.

In the present embodiment, referring to FIG. 3 and FIG. 5, either the first surface 511 or the second surface 611 is provided with a plurality of positioning posts 5112, the other of the first surface 511 and the second surface 611 is provided with a plurality of positioning grooves 6112, and the plurality of positioning posts 5112 are located within the plurality of positioning grooves 6112.

It can be understood that, in the present embodiment, since either the first surface 511 or the second surface 611 is provided with a plurality of positioning posts 5112, the other of the first surface 511 and the second surface 611 is provided with a plurality of positioning grooves 6112, and the plurality of positioning posts 5112 is located within the plurality of positioning grooves 6112. On the one hand, the plurality of positioning posts 5112 and the plurality of positioning grooves 6112 can perform a pre-positioning function to facilitate accurate connection of the inkjet device 600 with the cutting device 500. On the other hand, the cooperation of the plurality of positioning posts 5112 with the plurality of positioning grooves 6112 can perform a limiting function to reduce the risk of detachment between the inkjet device 600 and the cutting device 500.

In the present embodiment, referring to FIG. 3 and FIG. 5, the first surface 511 is provided with the plurality of positioning posts 5112 and the second surface 611 is provided with the plurality of positioning grooves 6112.

Alternatively, the second surface 611 is provided with the plurality of positioning posts 5112 and the first surface 511 is provided with the plurality of positioning grooves 6112.

In the present embodiment, referring to FIG. 3 and FIG. 5, the plurality of positioning posts 5112 are arranged at intervals, the plurality of positioning grooves 6112 are arranged at intervals, and each of the plurality of positioning grooves 6112 corresponds to one of the plurality of positioning posts 5112.

Alternatively, the plurality of positioning posts 5112 are arranged at intervals, the positioning groove 6112 is provided in plurality, and each of the plurality of positioning grooves 6112 corresponds to one of the plurality of positioning posts 5112. The connection between the inkjet device 600 and the cutting device 500 is realized by means of multi-point positioning, such that the inkjet device 600 and the cutting device 500 can achieve multi-point positioning at a plurality of positions. Thereby enhancing the stability of the connection between the inkjet device 600 and the cutting device 500.

In the present embodiment, referring to FIG. 3 and FIG. 5, the cutting device 500 further includes a first connection terminal 530, the first connection terminal 530 is disposed on the first surface 511. The inkjet device 600 further includes a second connection terminal 640, the second connection terminal 640 is disposed on the second surface 611. The second connection terminal 640 is electrically connected to the first connection terminal 530.

It can be understood that, in the present embodiment, since the cutting device 500 further includes a first connection terminal 530 disposed on the first surface 511, and the inkjet device 600 further includes a second connection terminal 640 disposed on the second surface 611. The second connection terminal 640 is electrically connected to the first connection terminal 530, signal transmission can be performed between the cutting device and the inkjet device.

In the present embodiment, referring to FIG. 1, the transmission device 400 is a conveyor belt transmission device 400, and the conveyor belt 410 of the conveyor belt transmission device 400 is fixed to either the inkjet device 600 or the cutting device 500.

It should be noted that, since the transmission device 400 is configured as a conveyor belt transmission device 400, and the conveyor belt 410 of the conveyor belt transmission device 400 is fixed to either the inkjet device 600 or the cutting device 500. That is, when the printing and cutting machine 10 is in operation, the conveyor belt 410 drives the cutting device 500 or the inkjet device 600 to move along the guide shaft 200, thereby ensuring that the printing and cutting machine can realize the printing function and the cutting function.

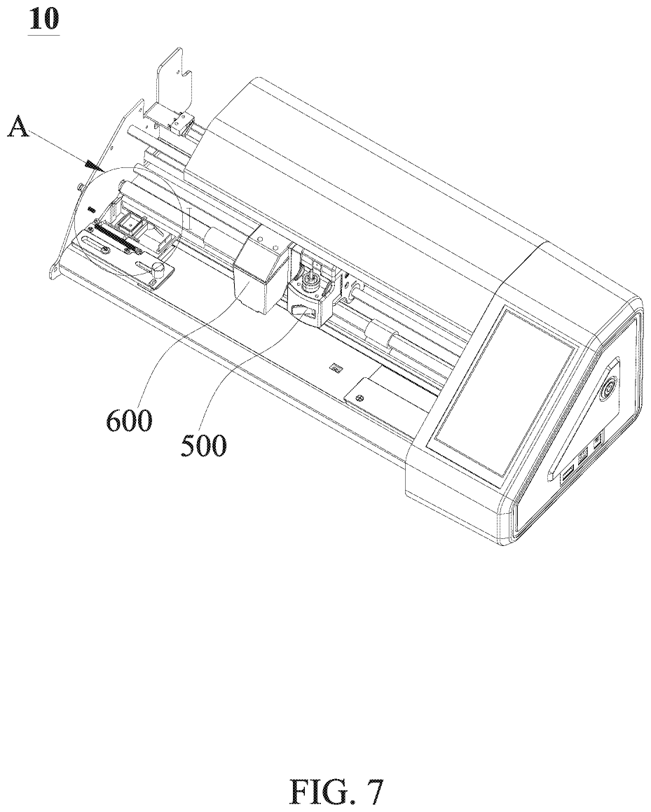

In the present embodiment, referring to FIG. 7, the printing and cutting machine further includes a moisturizing device 700, the moisturizing device 700 is disposed on the body 100. When the printing and cutting machine is in the first mode, the moisturizing device 700 covers the print head 630 of the inkjet device 600.

It can be understood that, in the present embodiment, the printing and cutting machine further includes a moisturizing device 700 disposed on the body 100. When the printing and cutting machine is in the first mode, the moisturizing device 700 covers the print head 630 of the inkjet device 600, the moisturizing device 700 is capable of moisturizing the print head 630 of the inkjet device 600.

It should be noted that the first mode is the state in which the printing and cutting machine is not in operation.

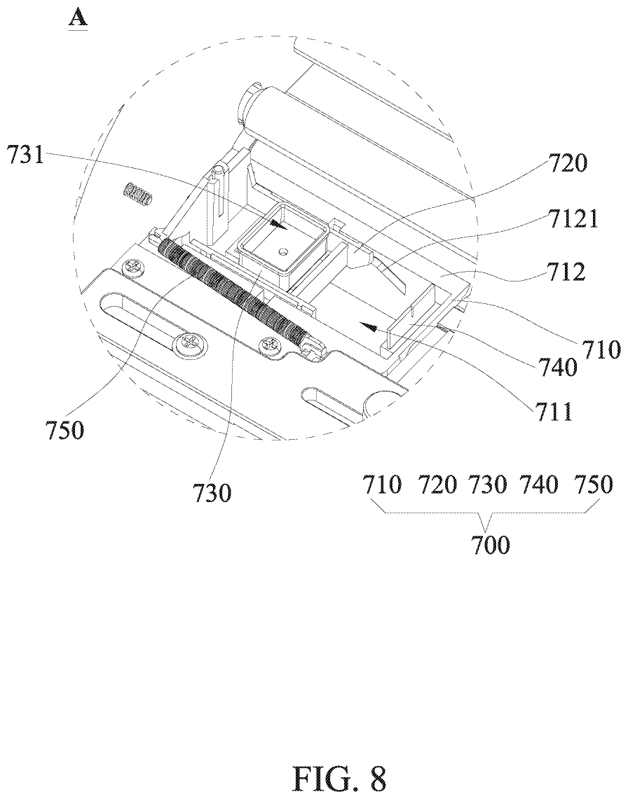

In the present embodiment, referring to FIG. 8, the moisturizing device 700 includes a first mounting base 710, a second mounting base 720 and a moisturizing component 730. The first mounting base 710 is mounted on the body 100, the first mounting base 710 is provided with a mounting cavity 711. The second mounting base 720 is disposed within the mounting cavity 711, and the second mounting base 720 is slidably connected to the first mounting base 710. The moisturizing component 730 is mounted on the second mounting base 720, the moisturizing component 730 is provided with a accommodating cavity 731. When the printing and cutting machine is in the first mode, at least a portion of the print head 630 of the inkjet device 600 is located within the accommodating cavity 731.

It should be noted that when the inkjet device 600 is not in use, the print head 630 of the inkjet device 600 is accommodated in the accommodating cavity 731.

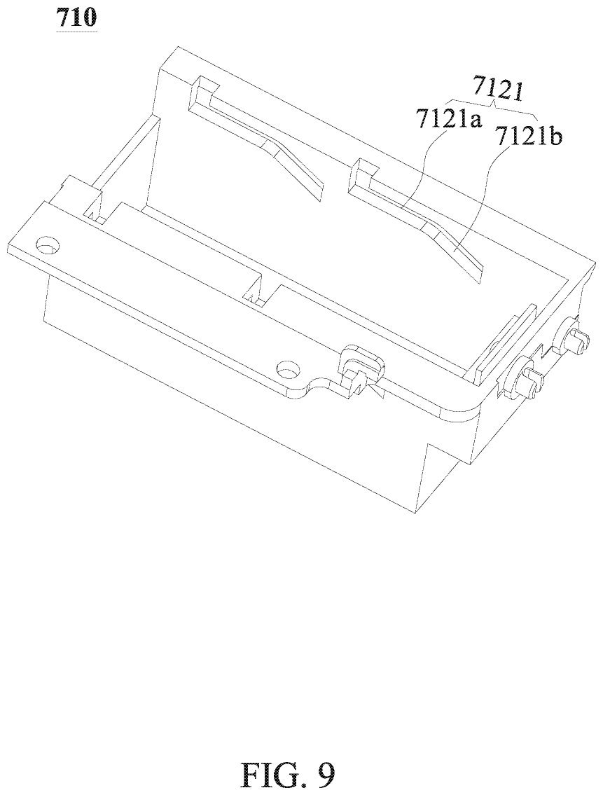

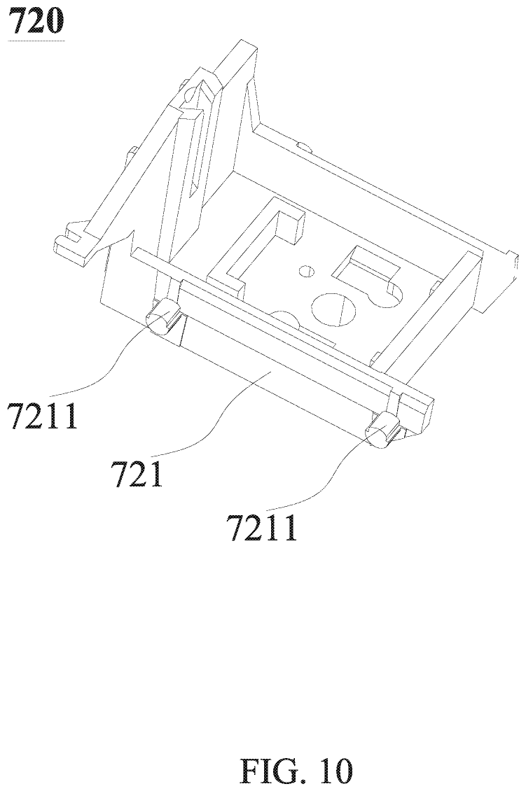

In the present embodiment, referring to FIG. 9 and FIG. 10, the first mounting base 710 includes a pair of first side plates 712 disposed opposite to each other, each of the first side plates 712 is provided with a guide groove 7121. The second mounting base 720 includes a pair of second side plates 721 disposed opposite to each other, a surface of each of the second side plates 721 is provided with a guide post 7211, and the guide post 7211 is slidably connected to the guide groove 7121.

It should be noted that, when the printing function is in use, the print head 630 of the inkjet device 600 drives the second mounting base 720 to slide within the mounting cavity 711. Specifically, the guide post slides within the guide groove 7121, so that the second mounting base 720 slides within the mounting cavity 711 along a preset path.

In the present embodiment, referring to FIG. 9, the guide groove 7121 includes a horizontal section 7121a and an inclined section 7121b. The inclined section 7121b is communicated with the horizontal section 7121a, and the inclined section 7121b is extended in a direction toward the bottom of the mounting cavity 711.

It is to be understood that, the guide groove 7121 is provided to include a horizontal section 7121a and an inclined section 7121b, the inclined section 7121b is in communication with the horizontal section 7121a, and the inclined section 7121b extends in a direction toward the bottom of the mounting cavity 711. That is, when the printing function is is operated, when the print head 630 of the inkjet device 600 drives the second mounting base 720 to slide within the mounting cavity 711 and pass through the region of the mounting cavity 711 corresponding to the inclined section 7121b, the second mounting base 720 moves downward, so that the print head 630 of the inkjet device 600 disengages from the accommodating cavity 731, thereby ensuring that the inkjet device 600 subsequently performs the inkjet printing function.

In the present embodiment, referring to FIG. 8, the moisturizing device 700 further includes a scraper 740, and the scraper 740 is mounted on the first mounting base 710.

It is to be understood that, the moisturizing device 700 is provided to further include the scraper 740, and the scraper 740 is mounted on the first mounting base 710. When the inkjet device 600 passes over the scraper 740, the scraper 740 is capable of scraping off condensed ink material on the print head 630 of the inkjet device 600, thereby ensuring that the ink of the inkjet device 600 flows out from the print head 630.

In the present embodiment, referring to FIG. 8, the moisturizing device 700 further includes a reset component 750, one end of the reset component 750 is connected to the first mounting base 710, and the other end of the reset component 750 is connected to the second mounting base 720.

In the present embodiment, the moisturizing device 700 further includes the reset component 750, one end of the reset component 750 is connected to the first mounting base 710, and the other end of the reset component 750 is connected to the second mounting base 720. After the second mounting base 720 is capable of moving downwardly so that the print head 630 of the inkjet device 600 is able to disengage from the accommodating cavity 731. The second mounting base 610 is capable of moving within the guide groove 7121 under the action of the reset component 750 and causes the second mounting base 610 to move in a direction away from the inkjet device 600, so that the second mounting base 610 returns to the initial position.

In the present embodiment, the reset component 750 is a spring.

In the present embodiment, the moisturizing device 700 further includes a sponge, and the sponge is disposed within the mounting cavity 711.

When the inkjet device 600 is operating, the inkjet device 600 is located at the initial position, the print head 630 of the inkjet device 600 drives the second mounting base 720 to slide within the mounting cavity 711. When the print head 630 of the inkjet device 600 drives the second mounting base 720 to slide within the mounting cavity 711 and pass through the region of the mounting cavity 711 corresponding to the inclined section 7121b, the second mounting base 720 is capable of moving downwardly, so that the print head 630 of the inkjet device 600 is able to disengage from the accommodating cavity 731. At this time, the inkjet device 600 continues to move in a direction away from the moisturizing device 700. When the print head 630 of the inkjet device 600 passes over the scraper 740, the scraper 740 is capable of scraping off condensed ink material on the print head 630 of the inkjet device 600, and the second mounting base 610 is capable of moving within the guide groove 7121 under the action of the reset component 750, so that the second mounting base 610 moves in a direction away from the inkjet device 600 and returns to the initial position.

It should be noted that, in the present embodiment, the inkjet device 600 is detachably connected to the cutting device 500, the inkjet device 600 is slidably connected to the guide shaft 200, and the inkjet device 600 is connected to the transmission device 400. That is, the inkjet device 600 is an inseparable part of the printing and cutting machine, and the inkjet device 600 is detachably connected to the cutting device 500 without being connected to other components of the printing and cutting machine. Therefore, the cutting device 500 can be separately detached from the printing and cutting machine, so that the printing and cutting machine can be used alone as a printer.

In the present embodiment, the cutting device 500 further includes a cutting head, and the cutting head is provided on the first base 510 so as to be movable upwardly and downwardly.

It is to be understood that, in the present embodiment, since the cutting head is provided on the first base 510 so as to be movable upwardly and downwardly. It is possible to control the cutting head to move in a direction toward the material to be cut, that is, the cutting head moves downwardly, so that the cutting device 500 is able to perform the cutting function. After the cutting of the material is completed, the cutting head moves in a direction away from the material, that is, the cutting head moves upwardly, so as to disengage from the position of the material.

The second embodiment of the present disclosure provides a first type of printing and cutting machine. Referring to FIG. 1 and FIG. 2, the printing and cutting machine 10 includes a body 100, a guide shaft 200, a driving device 300, a transmission device 400, a cutting device 500, and an inkjet device 600. The guide shaft 200 is provided on the body 100, the driving device 300 is provided on the body 100, the transmission device 400 is provided on the body 100, and the transmission device 400 is drivingly connected to the driving device 300. The inkjet device 600 is detachably connected to the cutting device 500, the inkjet device 600 is slidably connected to the guide shaft 200, and the inkjet device 600 is connected to the transmission device 400.

After material printing is completed, it is necessary to cut the material. Cutting machines are widely used in the production of advertising materials, the graphic quick-printing industry, and the cutting processing of office equipment and supplies. However, in conventional solutions, cutting machines are used for cutting and printers are used for printing. That is, existing cutting machines do not simultaneously possess both printing and cutting functions, resulting in a single application scenario for existing cutting machines. Therefore, the present disclosure provides a printing and cutting machine, by providing the cutting device 500 and the inkjet device 600 of the printing and cutting machine, and by providing that the inkjet device 600 is detachably connected to the cutting device 500, the inkjet device 600 is slidably connected to the guide shaft 200, and the inkjet device 600 is connected to the transmission device 400, so that the printing and cutting machine is able to simultaneously realize the printing function and the cutting function, thereby improving the diversity of application scenarios of the printing and cutting machine. The inkjet device 600 is detachably connected to the cutting device 500, the inkjet device 600 is slidably connected to the guide shaft 200, and the inkjet device 600 is connected to the transmission device 400. When the printing and cutting machine is used, the cutting device 500 can be detached and separated from the cutting device 500, so that the printing and cutting machine can be used alone as a printer, thereby improving the flexibility of the printing and cutting machine 10 during use.

As one usage mode of the printing and cutting machine of the present disclosure, when it is necessary to perform both printing and cutting functions on the material, the printing and cutting machine is operated, the inkjet device 600 is connected together with the printing device. The inkjet device 600 is firstly controlled to operate to realize printing on the material, after the material printing is completed, the cutting device 500 is controlled to operate and the inkjet device 600 stops operating, so as to realize the printing and cutting functions of the printing and cutting machine.

As another usage mode of the printing and cutting machine of the present disclosure, the cutting device 500 is separated from the inkjet device 600 to detach the cutting device 500 from the printing and cutting machine. So that the printing and cutting machine can be used as a device that only has the printing function and does not have the cutting function.

What is claimed is:

1. A printing and cutting machine, comprising:
a body;
a guide shaft disposed on the body;
a driving device disposed on the body;
a transmission device disposed on the body and in transmission connection with the driving device;
a cutting device; and
an inkjet device detachably connected to the cutting device;
wherein either the cutting device or the inkjet device is slidably connected to the guide shaft and is connected to the transmission device.

2. The printing and cutting machine of claim 1, wherein the cutting device is slidably connected to the guide shaft, and the cutting device is connected to the transmission device.

3. The printing and cutting machine of claim 1, wherein the inkjet device is slidably connected to the guide shaft, and the inkjet device is connected to the transmission device.

4. The printing and cutting machine of claim 1, wherein the cutting device comprises a first base having a first surface, the inkjet device comprises a second mounting base having a second surface; the cutting device further comprises a first magnetic assembly disposed on the first surface, the inkjet device further comprises a second magnetic assembly disposed on the second surface; and the second magnetic assembly is magnetically connected to the first magnetic assembly.

5. The printing and cutting machine of claim 4, wherein the first surface is provided with a first groove, and the second surface is provided with a second groove;
wherein at least a portion of the first magnetic assembly is disposed in the first groove, and at least a portion of the second magnetic assembly is disposed in the second groove.

6. The printing and cutting machine of claim 5, wherein a surface of the first magnetic assembly away from a bottom of the first groove is flush with the first surface, and a surface of the second magnetic assembly away from a bottom of the second groove is flush with the second surface.

7. The printing and cutting machine of claim 5, wherein a portion of the first magnetic assembly is received in the first groove and a portion of the first magnetic assembly protrudes outward from the first surface, and a portion of the second magnetic assembly is received in the second groove and a portion of the second magnetic assembly protrudes outward from the second surface.

8. The printing and cutting machine of claim 4, wherein the first magnetic assembly comprises a plurality of first magnetic components arranged at intervals; and
the second magnetic assembly includes a plurality of second magnetic components arranged at intervals;
wherein each of the plurality second magnetic components corresponds to each of the plurality of the first magnetic components.

9. The printing and cutting machine of claim 4, wherein one of the first surface and the second surface is provided with a plurality of positioning posts, the other of the first surface and the second surface is provided with a plurality of positioning grooves, and the plurality of positioning posts are located in the plurality of positioning grooves.

10. The printing and cutting machine of claim 9, wherein the plurality of positioning posts are arranged at intervals; the plurality of positioning grooves are arranged at intervals, and each of the plurality of positioning grooves corresponds to one of the plurality of positioning posts.

11. The printing and cutting machine of claim 4, wherein the cutting device further comprises a first connection terminal disposed on the first surface, the inkjet device further comprises a second connection terminal disposed on the second surface; and the second connection terminal is electrically connected to the first connection terminal.

12. The printing and cutting machine of claim 1, wherein the transmission device is a conveyor belt transmission device, and a conveyor belt of the conveyor belt transmission device is fixed to either the inkjet device or the cutting device.

13. The printing and cutting machine of claim 1, wherein the printing and cutting machine further comprises a moisturizing device disposed on the body;
wherein, when the printing and cutting machine is in a first mode, the moisturizing device covers an inkjet head of the inkjet device.

14. The printing and cutting machine of claim 13, wherein the moisturizing device comprises:
a first mounting base mounted on the body, the first mounting base being provided with a mounting cavity;
a second mounting base disposed in the mounting cavity, and the second mounting base being slidably connected to the first mounting base;
a moisturizing component mounted on the second mounting base, the moisturizing component being provided with an accommodating cavity;
wherein, when the printing and cutting machine is in the first mode, at least a portion of the inkjet head of the inkjet device is located in the accommodating cavity.

15. The printing and cutting machine of claim 14, wherein the first mounting base comprises a pair of first side plates disposed opposite to each other, each of the first side plates is provided with a guide groove;
the second mounting base comprises a pair of second side plates disposed opposite to each other; and
wherein a surface of each of the second side plates is provided with a guide post, and the guide post is slidably connected to the corresponding guide groove.

16. The printing and cutting machine of claim 15, wherein the guide groove comprises a horizontal section and an inclined section, the inclined section communicates with the horizontal section, and the inclined section extends in a direction toward a bottom of the mounting cavity.

17. The printing and cutting machine of claim 14, wherein the moisturizing device further comprises a scraper mounted on the first mounting base.

18. The printing and cutting machine of claim 14, wherein the moisturizing device further comprises a reset component, one end of the reset component is connected to the first mounting base, and the other end of the reset component is connected to the second mounting base.

19. The printing and cutting machine of claim 18, wherein the reset component is a spring.

20. The printing and cutting machine of claim 14, wherein the moisturizing device further comprises a sponge disposed in the mounting cavity.
